(19) United States
(12) Patent Application Publication
(10) Pub. No.: US 2024/0170638 A1
(43) Pub. Date: May 23, 2024

(54) SOLID-STATE BATTERY AND METHOD OF MANUFACTURING SOLID-STATE BATTERY

(71) Applicants: TOYOTA JIDOSHA KABUSHIKI KAISHA, Toyota-shi Aichi-ken (JP); Panasonic Holdings Corporation, Kadoma-shi Osaka (JP)

(72) Inventors: Akio MITSUI, Anjo-shi Aichi-ken (JP); Kenji NAGAO, Toyota-shi Aichi-ken (JP); Izuru SASAKI, Toyota-shi Aichi-ken (JP)

(73) Assignees: TOYOTA JIDOSHA KABUSHIKI KAISHA, Toyota-shi Aichi-ken (JP); Panasonic Holdings Corporation, Kadoma-shi Osaka (JP)

(21) Appl. No.: 18/512,677

(22) Filed: Nov. 17, 2023

(30) Foreign Application Priority Data
Nov. 22, 2022 (JP) 2022-186940

(51) Int. Cl. H01M 4/04; H01M 10/0525; H01M 10/0562

(52) U.S. Cl. CPC H01M 4/0447; H01M 10/0525; H01M 10/0562; H01M 2300/0068

(57) ABSTRACT

A method of manufacturing a solid-state battery, the method including: over-discharging the solid-state battery having a solid sulfide electrolyte layer.

### CROSS-REFERENCE TO RELATED APPLICATIONS

This application claims priority under 35 USC 119 from Japanese Patent Application No. 2022-186940 filed on Nov. 22, 2022, the disclosure of which is incorporated by reference herein in its entirety.

### BACKGROUND

### Technical Field

The present disclosure relates to a solid-state battery and a method of manufacturing a solid-state battery.

### Related Art

In recent years, secondary batteries such as lithium ion secondary batteries and the like have been suitably used as the portable power source of personal computers, portable terminals and the like, and the power source for the driving of vehicles such as electric vehicles (EVs), hybrid vehicles (HVs), plug-in hybrid vehicles (PHV) and the like, and the like.

The manufacturing of solid-state batteries requires confirming the absence/presence of short-circuiting in advance before the battery is shipped-out, eliminating defective products that have short-circuited, and preventing the release of defective products. In particular, in solid-state batteries having a solid sulfide electrolyte layer, the sulfide (e.g., CuS or the like), which is formed by the reaction of a metal component that becomes mixed into the solid sulfide electrolyte layer and the sulfur component that is contained in the solid sulfide electrolyte layer, can become a cause of short-circuiting.

Japanese Patent Application Laid-Open (JP-A) No. 2020-191183 for example confirms the absence/presence of short-circuiting of a battery by carrying out aging, i.e., heating processing over a long time, before the initial charging of a battery.

### SUMMARY

However, in conventional solid-state battery manufacturing methods, because defective products that may short-circuit are discriminated through a process of heating over a long time as in JP-A No. 2020-191183, it is difficult to quickly identify the absence/presence of short-circuiting of a battery before shipping-out and quickly prevent release of a defective product.

An object of the present disclosure is to provide a solid-state battery and a method of manufacturing a solid-state battery that can confirm the absence/presence of short-circuiting of a solid-state battery before shipping and can quickly prevent release of a defective product.

<1> A method of manufacturing a solid-state battery, the method including: preparing a solid-state battery having a positive electrode layer, a negative electrode layer, and a solid sulfide electrolyte layer disposed between the positive electrode layer and the negative electrode layer; and over-discharging the solid-state battery.

<2> The method of manufacturing a solid-state battery of <1>, wherein the over-discharging includes over-discharging the solid-state battery by applying voltage of less than −0.5 V.

<3> The method of manufacturing a solid-state battery of <1> or <2>, wherein, in the over-discharging, the solid-state battery is over-discharged in a temperature range of from 25° C. to 150° C.

<4> The method of manufacturing a solid-state battery of <3>, wherein, in the over-discharging, the solid-state battery is over-discharged in a temperature range of from 60° C. to 85° C.

<5> A solid-state battery, manufactured by the method of manufacturing a solid-state battery of any one of <1> to <4>.

In accordance with the present disclosure, there are provided a solid-state battery and a method of manufacturing a solid-state battery that can confirm the absence/presence of short-circuiting of a solid-state battery before shipping and can quickly prevent release of a defective product.

### DETAILED DESCRIPTION

In the present specification, numerical ranges expressed by using “˜” mean ranges in which the numerical values listed before and after the “˜” are included as the minimum value and maximum value.

In numerical value ranges that are expressed in a stepwise manner in the present disclosure, the upper limit value or the lower limit value listed in a numerical value range may be substituted by the upper limit value or the lower limit value of another numerical value range that is expressed in a stepwise manner. Further, in the numerical value ranges put forth in the present disclosure, the upper limit value or the lower limit value of a numerical value range may be substituted by a value shown in the Examples.

In the present disclosure, in a case in which there are plural materials corresponding to respective components in a composition, the amount of the respective components in the composition means the total amount of the plural materials existing in the composition, unless otherwise indicated.

In the present disclosure, the term “step” is not only an independent step and includes steps that, in a case in which that step cannot be clearly distinguished from another step, achieve the intended object of that step.

Embodiments that are examples of the present disclosure are described hereinafter. The description thereof and the Examples are for exemplifying the embodiments, and are not intended to limit the scope of the present disclosure.

<Method of Manufacturing Solid-State Battery>

The method of manufacturing a solid-state battery of the present disclosure is a method of manufacturing a solid-state battery, the method including: preparing a solid-state battery having a positive electrode layer, a negative electrode layer, and a solid sulfide electrolyte layer disposed between the positive electrode layer and the negative electrode layer; and over-discharging the solid-state battery.

Over-discharging means, before charging, applying voltage between the electrodes, causing electrons to flow from the negative electrode toward the positive electrode, and generating current.

In accordance with the method of manufacturing a solid-state battery of the present disclosure, a sulfide can be accelerated from the negative electrode side to the positive electrode side by over-discharging, by utilizing the fact that the sulfide, which is generated by the reaction of a metal component that becomes mixed into the solid sulfide electrolyte layer (e.g., the metallic copper contained in the negative electrode layer or the like), and the sulfur component contained in the solid sulfide electrolyte layer, is an electron conductor. Due thereto, the absence/presence of short-circuiting caused by a foreign metal that becomes mixed into the solid sulfide electrolyte layer of the solid-state battery can be confirmed before shipping, and the release of a solid-state battery that is a defective product can be prevented quickly.

Further, in accordance with the method of manufacturing a solid-state battery of the present disclosure, deterioration of the solid-state battery that arises in the process of confirming the absence/presence of short-circuiting of the solid-state battery is reduced. In conventional methods of manufacturing a solid-state battery, in order to confirm the absence/presence of short-circuiting of a solid-state battery, an aging process, i.e., leaving the solid-state battery in a high-temperature environment over a long period of time (e.g., around 30 days at 80° C.), is carried out. However, there are cases in which, in this process, the materials contained in the solid-state battery degrade due to heat, and the battery performances deteriorate (more specifically, the resistance value increases). With regard to this point, in accordance with the method of manufacturing a solid-state battery of the present disclosure, deterioration of a solid-state battery can be reduced because the absence/presence of short-circuiting at the solid-state battery can be confirmed quickly due to the solid-state battery undergoing the over-discharging.

At the solid-state battery of the present disclosure that is manufactured by having undergone the over-discharging, the concentration of a foreign metal that becomes mixed into the solid sulfide electrolyte layer is diffused in the direction opposite the direction in which the over-discharge voltage is applied (i.e., is diffused in the direction heading from the negative electrode side toward the positive electrode side). On the other hand, at a solid-state battery that is manufactured without undergoing an over-discharging, the foreign metal that becomes mixed into the solid sulfide electrolyte layer tends to be diffused three-dimensionally in the form of concentric circles. Therefore, by analyzing, from a cross-section of the solid-state battery or the like, the concentration gradient of a foreign metal in a vicinity of a region where the foreign metal likely became mixed in, it can be confirmed that a solid-state battery has been manufactured by having undergone an over-discharging.

Details of the method of manufacturing a solid-state battery of the present disclosure are described step-by-step hereinafter.

[Battery Preparation]

In the battery preparation, a solid-state battery having a positive electrode layer, a negative electrode layer, and a solid sulfide electrolyte layer disposed between the positive electrode layer and the negative electrode layer, is prepared. The positive electrode layer contains, for example, a layer containing a positive electrode active material, and a collector foil. The negative electrode layer contains, for example, a negative electrode active material layer and a collector foil.

A known solid-state battery can be used provided that it has a positive electrode layer, a negative electrode layer, and a solid sulfide electrolyte layer disposed between the positive electrode layer and the negative electrode layer. Materials similar to those exemplified in JP-A No. 2020-191183 are examples of concrete materials of the positive electrode layer, the negative electrode layer, and the solid sulfide electrolyte layer.

[Over-Discharging]

In the over-discharging, the solid-state battery is over-discharged.

In the over-discharging, for example, the solid-state battery may be over-discharged in a temperature range of from 25° C., or the solid-state battery may be over-discharged in a temperature range of from 30° C., or the solid-state battery may be over-discharged in a temperature range of from 50° C.

In some embodiments, the over-discharging, from the standpoint of more efficiently accelerating the short-circuiting component (e.g., the sulfide), which is generated at the solid sulfide electrolyte layer, from the negative electrode side to the positive electrode side, and confirming short-circuiting more quickly, the solid-state battery may be over-discharged in a temperature range of from 25° C. to 150° C., the solid-state battery may be over-discharged in a temperature range of from 60° C. to 85° C., or the solid-state battery may be over-discharged in a temperature range of from 70° C. to 85° C.

In some embodiments, from the standpoint of reducing deterioration of the battery, in the over-discharging, the solid-state battery may be over-discharged in a temperature range of less than or equal to 250° C., the solid-state battery may be over-discharged in a range of less than or equal to 200° C., or the solid-state battery may be over-discharged in a range of less than or equal to 150° C. Note that, in a case in which the exterior of the battery is laminated, there may be an aspect in which the solid-state battery is over-discharged in a temperature range of less than or equal to 100° C.

As one aspect, for example, in the over-discharging, over-discharging may be carried out while the solid-state battery is placed within a thermostat and is heated.

Techniques for over-discharging the solid-state battery are not particularly limited. The solid-state battery may self-discharge, or may be electrically connected to a discharging device and discharged. In some embodiments, from the standpoint of more efficiently accelerating the short-circuiting component (e.g., the sulfide), which is generated at the solid sulfide electrolyte layer, from the negative electrode side to the positive electrode side, and confirming short-circuiting more quickly, the solid-state battery may be electrically connected to a discharging device and discharge the solid-state battery.

In some embodiments, from the standpoint of more efficiently accelerating the short-circuiting component (e.g., the sulfide), which is generated at the solid sulfide electrolyte layer, from the negative electrode side to the positive electrode side, and confirming short-circuiting more quickly, the over-discharging includes over-discharging the battery by applying a voltage of less than −0.5 V, the over-discharging includes over-discharging the battery by applying a voltage that is greater than or equal to −7.0 V and less than or equal to −1.0 V, or the over-discharging includes over-discharging the battery by applying a voltage that is from −6.5 V to −1.5 V.

In some embodiments, from the standpoint of more efficiently accelerating the short-circuiting component (e.g., the sulfide), which is generated at the solid sulfide electrolyte layer, from the negative electrode side to the positive electrode side, and confirming short-circuiting more quickly, as one aspect, the over-discharging includes over-discharging the solid-state battery by applying voltage while heating, pr the over-discharging includes over-discharging the solid-state battery by applying voltage that is less than or equal to −1.5 V in a temperature range of from 60° C. to 85° C.

(Others)

As needed, the method of manufacturing a solid-state battery of the present disclosure may further include other than the battery preparation and the over-discharging. Examples of others are:
1) eliminating a solid-state battery that has a short-circuit, from the over-discharging on;
2) the solid-state battery, from the over-discharging on;
3) an initial charging step of initially charging the solid-state battery, from the battery preparation on (in some embodiments, from the over-discharging on);
4) discharging the solid-state battery, from the battery preparation on (in some embodiments, from the initial charging on);
5) stacking the solid-state batteries, from the battery preparation on;
6) cutting the solid-state batteries, from the battery preparation on, and the like. Note that above 3) through 6) are desirable when shipping-out solid-state batteries at which it has been confirmed that there are no short circuits caused by short-circuiting components (e.g., a sulfide) that are generated in the solid sulfide electrolyte layer.

As one aspect, the method of manufacturing a solid-state battery of the present disclosure may include an initial charging and a discharging, after the over-discharging.

<Solid-State Battery>

The solid-state battery of the present disclosure is manufactured by the method of manufacturing a solid-state battery relating to the present disclosure.

In accordance with the present disclosure, as described above, in the manufacturing, because the absence/presence of short-circuiting of a solid-state battery is confirmed before shipping and the releasing of a defective product that has short-circuited is prevented quickly, there can be obtained a solid-state battery that does not have a short-circuit caused by a foreign metal that has become mixed into the solid sulfide electrolyte layer.

### EXAMPLES

### Example 1

1. Fabrication of Paste for Positive Electrode Layer

A mixture, which was obtained by mixing together positive electrode active material LiNi_{0.8}(CoAl)_{0.2}O₂ in which LiNbO₃ was subjected to a surface treatment, conductive carbon, a solid electrolyte, a binder resin and a solvent by using an ultrasonic homogenizer (UH-50 manufactured by SMT Co., Ltd.), was used as a paste for the positive electrode layer.

2. Fabrication of Paste for Negative Electrode Layer

A mixture, which was obtained by Li₄Ti₅O₁₂, conductive carbon, a binder resin and a solvent being mixed together for 30 minutes by using an ultrasonic homogenizer (UH-50 manufactured by SMT Co., Ltd.), and thereafter, a solid electrolyte being mixed therewith and mixing being carried out for 30 minutes by using an ultrasonic homogenizer (UH-50 manufactured by SMT Co., Ltd.), was used as a paste for the negative electrode layer.

3. Fabrication of Paste for Solid sulfide Electrolyte Layer

A solution containing a solvent and a binder resin in an amount of 5 mass %, and an LiI—LiBr—Li₂S—P₂S₅ glass ceramic of an average particle diameter of 2.5 μm that was the solid sulfide electrolyte, were mixed together in a container made of polypropylene by using an ultrasonic homogenizer (UH-50 manufactured by SMT Co., Ltd.). Next, this mixed liquid was shaken for 30 seconds in a shaker, and was used as a paste for the solid sulfide electrolyte layer.

4. Fabrication of Sheets for Respective Layers

The paste for the positive electrode layer was coated on an aluminum foil by a blade method using an applicator. After coating, drying was carried out for 30 minutes on a hot press of 100° C., and a sheet for the positive electrode layer was obtained. The paste for the solid sulfide electrolyte layer was coated on the surface of an aluminum foil by a blade method using an applicator. Drying was carried out for 30 minutes on a hot press of 100° C., and a sheet for the solid sulfide electrolyte layer was obtained. The paste for the negative electrode layer was coated on the surface of a copper foil by a blade method using an applicator, and drying was carried out for 30 minutes on a hot press of 100° C., and a sheet for the negative electrode layer was obtained.

5. Fabrication of Lithium Ion Secondary Battery

The above-described sheet for the negative electrode layer and sheet for the solid sulfide electrolyte layer were layered in that order and pressed, and the aluminum foil of the solid sulfide electrolyte layer was peeled-off. Due thereto, the solid sulfide electrolyte layer was transferred onto the surface, at the side that did not have the copper foil, of the negative electrode layer, and a layered body of a solid sulfide electrolyte layer/negative electrode (negative electrode layer/aluminum foil) was obtained. Next, the sheet for the positive electrode layer was layered on the surface, at the solid sulfide electrolyte layer side, of the layered body, such that the surface, at the side that did not have the aluminum foil, of the sheet for the positive electrode layer contacted the layered body, and roll pressing was carried out at 165° C. and 5 ton/cm. A layered body having a positive electrode (aluminum foil/positive electrode layer), the solid sulfide electrolyte layer, and the negative electrode in that order was obtained. This layered body was laminate-sealed and was restrained at 5 MPa, and a lithium ion secondary battery that was a solid-state battery was prepared. Due to this solid-state battery using a copper foil as the collector foil at the negative electrode side, the solid-state battery was a lithium ion secondary battery having a structure that easily short-circuited artificially.

6. The lithium ion secondary battery that was prepared in above 5 was placed in a thermostat of the temperature shown in Table 1, and the battery was connected to a charging/discharging device. Then, constant current discharging of the battery was carried out at 0.1 C equivalent, and the cell voltage reached −0.1 V, and thereafter, constant voltage discharging was started at the voltage shown in Table 1. The constant voltage discharging was ended when the cell voltage rose and reached 0 V and it was considered that short-circuiting had occurred. The time until short-circuiting occurred is shown in Table 1. Short-circuiting of the solid-state battery was observed as described above, and it was confirmed that the solid-state battery was a defective product.

### Examples 2 and 3

1.-5. A lithium ion secondary battery that was a solid-state battery was prepared by the same method as in Example 1.

6. Short-circuiting of defective solid-state batteries was observed, and short-circuited batteries were judged to be defective products, in accordance with the same specifications as in Example 1 except that the temperature of the thermostat interior and the over-discharge voltage were made to be those shown in Table 1. The time until short-circuiting occurred is shown in Table 1.

### Comparative Example 1

1.-5. A lithium ion secondary battery that was a solid-state battery was prepared by the same method as in Example 1.

6. Instead of the over-discharging, an aging processing of leaving the solid-state battery in a thermostat of 80° C. was carried out as described in JP-A No. 2020-191183. The time until short-circuiting occurred is shown in Table 1. For convenience, the aging temperature (marked by an asterisk) is listed in the “over-discharge temperature” column in Table 1, but an over-discharging was not carried out in Comparative Example 1.

TABLE 1

| | negative | over- | over- | short- | |
|---|---|---|---|---|---|
| | electrode | discharge | discharge | circuiting | |
| | collector | temperature | voltage | occurrence | |
| | foil | (° C.) | (V) | time | |
| Example 1 | copper foil | 80 | −1.0 | 10 | h |
| Example 2 | copper foil | 80 | −1.8 | 3 | h |
| Example 3 | copper foil | 60 | −1.0 | 120 | h |
| Comparative | copper foil | 80* | — | 30 | days |
| Example 1 | | | | | |

As described above, it can be understood that, as compared with the manufacturing method of the Comparative Example, the manufacturing methods of the Examples could confirm the absence/presence of short-circuiting in a solid-state battery in a short time before shipping, and could quickly prevent the release of defective products.

### Example 4

1.-3. A paste for the positive electrode layer, a paste for the negative electrode layer, and a paste for the solid sulfide electrolyte layer were obtained by the same techniques as those of the method described in Example 1.

4. Fabrication of Sheets of Respective Layers

The sheet for the positive electrode layer and the sheet for the solid sulfide electrolyte layer were obtained by the same techniques as those of the method described in Example 1. Further, the sheet for the negative electrode layer was obtained by the same technique as that of the method described in Example 1, except that an aluminum foil was used instead of the copper foil.

5. A lithium ion secondary battery that was a solid-state battery was obtained by the same technique as that of the method described in Example 1.

6. The lithium ion secondary battery that was prepared in above 5 was placed in a thermostat of the temperature shown in Table 2, and the battery was connected to a charging/discharging device. Then, constant current discharging of the battery was carried out at 0.1 C equivalent, and after the battery reached −1.8 V, constant voltage discharging was carried out at −1.8 V, and after 10 hours passed, the over-discharge test was ended. Thereafter, constant current charging of the battery was carried out at a 0.3 C equivalent, and after a voltage equivalent to 40% of the depth of charge was reached, constant voltage charging was carried out, and the charging was ended when a current of 0.01 C was reached. Thereafter, constant current discharging was carried out at a current of 46 C equivalent. The resistance value was calculated by dividing the difference between the voltage before charging and the voltage after discharging for 0.1 seconds by a 46 C equivalent current. The obtained resistance value was used as a relative value with respect to the resistance value of the solid-state battery before the over-discharging was carried out (in Table 2, the “initial value” in the “relative resistance value”), and is shown in Table 2. The resistance increase ratio was calculated by dividing this relative resistance value after the over-discharging by the relative resistance value before the over-discharging. The time until short-circuiting occurred, the resistance values, and the value of the resistance increase ratio are shown in Table 2. Note that, in the table, in the solid-state battery of Example 4, short-circuiting was not observed even though the over-discharging was carried out for 10 hours, and therefore, the “short-circuiting occurrence time” (marked with an asterisk in Table 2) indicates the “measurement end time”.

As described above, it was understood that it could be confirmed, in a short time and before shipping, that there was no short-circuiting in the solid-state battery manufactured in Example 4.

### Comparative Example 2

1.-5. A lithium ion secondary battery that was a solid-state battery was obtained by the same method as in Example 4.

6. Instead of the over-discharging, an aging processing of leaving the solid-state battery in a thermostat of 80° C. was carried out as described in JP-A No. 2020-191183. Thereafter, constant current charging of the battery was carried out at a 0.3 C equivalent, and after a voltage equivalent to 40% of the depth of charge was reached, constant voltage charging was carried out, and the charging was ended when a current of 0.01 C was reached. Thereafter, constant current discharging was carried out at a current of 46 C equivalent. The resistance value was calculated by dividing the difference between the voltage before charging and the voltage after discharging for 0.1 seconds by a 46 C equivalent current. The obtained resistance values before and after the aging processing were used as relative values with respect to the initial resistance value of the solid-state battery before the over-discharging in Example 4 was carried out, and are shown in Table 2. Further, the resistance increase ratio was calculated by dividing the relative resistance value after the aging processing by the relative resistance value before the aging processing. The time until short-circuiting occurred, the resistance values, and the value of the resistance increase ratio are shown in Table 2. Note that, for convenience, the aging temperature (marked by an asterisk in Table 2) is listed in the “over-discharge temperature” column of Table 2, but the over-discharging was not carried out in Comparative Example 2.

In Table 2, the “initial” in the “relative resistance value” column means the resistance value of the solid-state battery before the aging or the over-discharging was carried out. In Table 2, the “at end time” in the “relative resistance value” column means the resistance value of the solid-state battery at the time when the aging or the over-discharging was ended. The respective resistance values in Table 2 are relative resistance values that are based on the initial resistance value in Example 4.

TABLE 2

| | negative | over- | over- | short- | relative resistance | | |
|---|---|---|---|---|---|---|---|
| | electrode | discharge | discharge | circuiting | value | | resistance |
| | collector | temperature | voltage | occurrence | | at end | increase |
| | foil | (° C.) | (V) | time | initial | time | ratio |
| Example 4 | aluminum | 80 | −1.8 | 10 h* | 1.00 | 1.14 | 1.14 |
| | foil | | | | | | |
| Comparative | aluminum | 80* | — | 30 days | 0.99 | 1.78 | 1.80 |
| Example 2 | foil | | | | | | |

As described above, it can be understood that, as compared with the manufacturing method of the Comparative Example, in the manufacturing method of the Example, a short time sufficed to confirm the absence/presence of short-circuiting at the solid-state battery, and therefore, an increase in the resistance value of the solid-state battery was reduced, i.e., deterioration of the solid state battery was reduced.

What is claimed is:

1. A method of manufacturing a solid-state battery, the method comprising:
preparing a solid-state battery having a positive electrode layer, a negative electrode layer, and a solid sulfide electrolyte layer disposed between the positive electrode layer and the negative electrode layer; and
over-discharging the solid-state battery.

2. The method of manufacturing a solid-state battery of claim 1, wherein the over-discharging comprises over-discharging the solid-state battery by applying voltage of less than −0.5 V.

3. The method of manufacturing a solid-state battery of claim 1, wherein, in the over-discharging, the solid-state battery is over-discharged in a temperature range of from 25° C. to 150° C.

4. The method of manufacturing a solid-state battery of claim 3, wherein, in the over-discharging, the solid-state battery is over-discharged in a temperature range of from 60° C. to 85° C.

5. A solid-state battery, manufactured by the method of manufacturing a solid-state battery of claim 1.
